(19) United States
(12) Patent Application Publication
(10) Pub. No.: US 2008/0176730 A1
(43) Pub. Date: Jul. 24, 2008

(54) Method of fabricating a double-glazing container

(76) Inventor: Huang Piao Chen, Shanghai City (TW)

Correspondence Address: TROXELL LAW OFFICE PLLC, SUITE 1404, 5205 LEESBURG PIKE, FALLS CHURCH, VA, 22041, US

(21) Appl. No.: 11/655,279

(22) Filed: Jan. 19, 2007

(51) Int. Cl. C03C 8/24

(52) U.S. Cl. 501/15

(57) ABSTRACT

A method of fabricating a double-glazing container is disclosed. The double-glazing container comprises an inner glass and an outer glass that are combined with each other by fusing, perforating and bottom-sealing. A handle may be attached thereon or a beak may be shaped if desired. The resultant double-glazing container is beautiful, and is able to keep warmth and isolate heat for a long time.

### CROSS-REFERENCES TO RELATED APPLICATIONS

Not Applicable

### STATEMENT REGARDING FEDERALLY SPONSORED RESEARCH OR DEVELOPMENT

Not Applicable

### DESCRIPTION

1. Field of the Invention

The present invention relates to a method of fabricating a double-glazing container, which includes performing the steps of fusing, perforating and bottom-sealing to integrate the inner glass with the outer glass of a container, as well as forming a handle or a beak on the container if desired, so as to fabricate an artistic double-glazing container capable of keeping warmth and isolating heat.

2. Background of the Invention

Glass containers are usually used for containing manifold goods, especially for liquid drinks. The common containers include cups, teakettles, or pots for cold or hot drinks. Conventionally, such glass containers are in the form of a single layer.

However, single-glazing containers fail to keep warmth for a long time. Also, it is not easy to form an aesthetic single-glazing container, and the quality of the products is not satisfying. In order to overcome the aforesaid problems, manufacturers tend to thicken the glass of a container but cause additional issues. So it is still not the best solution.

Accordingly, an improved method is provided to integrate the inner glass with the outer glass of a container through fusing, perforating and bottom-sealing, so as to fabricate an artistic double-glazing container capable of keeping warmth and isolating heat.

### SUMMARY OF THE INVENTION

It is a primary object of the invention to provide a method of manufacturing a double-glazing container.

In accordance with the object of the invention, a method of fabricating a double-glazing container is provided. The double-glazing container comprises an inner glass and an outer glass that are combined with each other by fusing, perforating and bottom-sealing. A handle may be attached thereon or a beak may be shaped if desired. The resultant double-glazing container is beautiful, and is able to keep warmth and isolate heat for a long time.

The foregoing aspects, as well as many of the attendant advantages and features of this invention will become more apparent by reference to the following detailed description, when taken in conjunction with the accompanying drawings.

### BRIEF DESCRIPTION OF THE DRAWINGS

FIG. 1 schematically illustrates a U-shaped inner glass and a tubular outer glass before being fused according to an embodiment of the invention.

FIG. 2 is a schematic diagram showing that a U-shaped inner glass is fused with the top edge of a tubular outer glass according to an embodiment of the invention.

FIG. 3 is a schematic diagram showing that the bottom of a tubular outer glass is punched and sealed according to an embodiment of the invention.

FIG. 4 schematically illustrates a tubular outer glass having an attached handle and a beak according to an embodiment of the invention.

### DETAILED DESCRIPTION OF SOME EMBODIMENTS

It is a primary object of the invention to provide a method of manufacturing a double-glazing container.

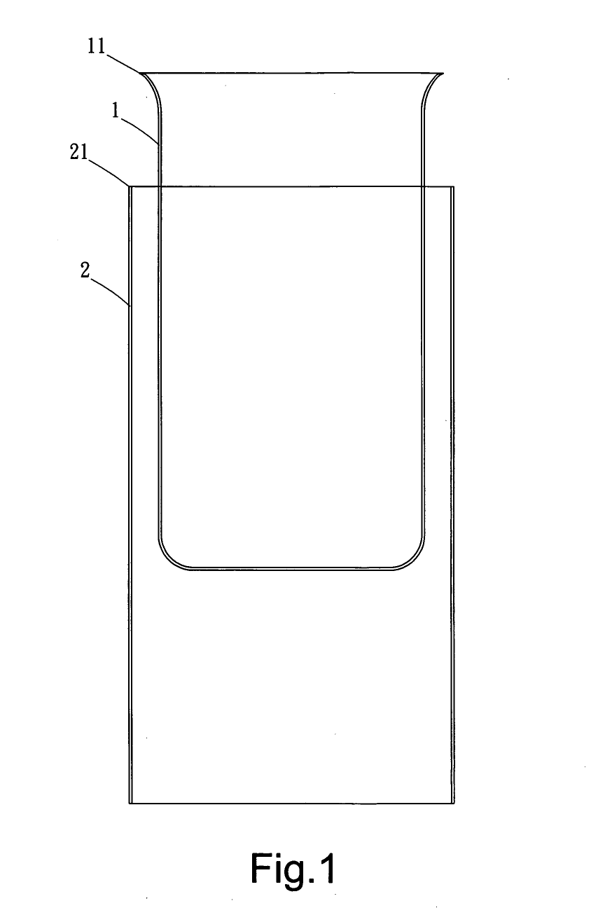

Referring to FIG. 1, a U-shaped inner glass (1) is disposed into a tubular outer glass (2). The U-shaped inner glass (1) and the tubular outer glass (2) are then fused with each other, and the bottom of the tubular outer glass (2) is sealed to form a double-glazing container in accordance with the method to fabricate a double-glazing container in one embodiment of the invention.

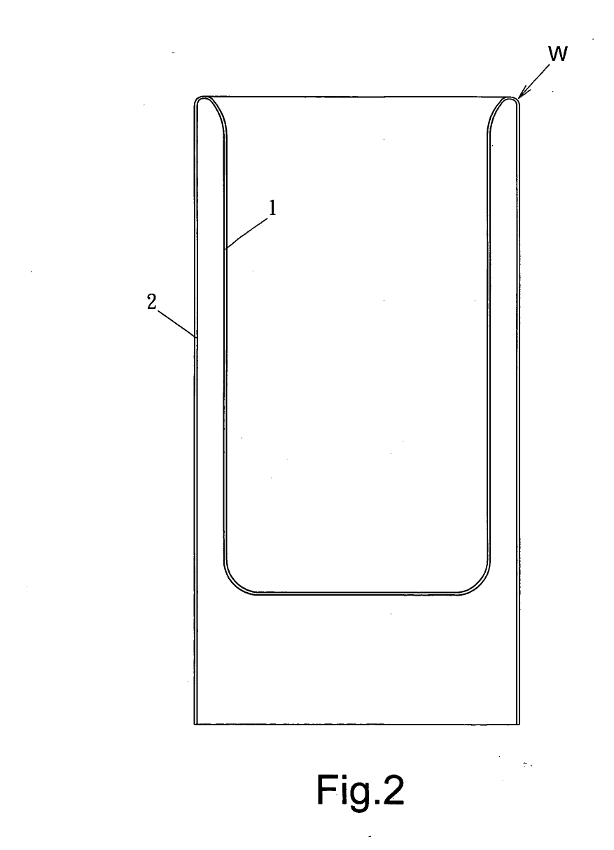

Referring to FIG. 2, the top edge (11) of the U-shaped inner glass (1) and the top edge (21) of the tubular outer glass (2) are fused together as indicated by an arrow W in FIG. 2.

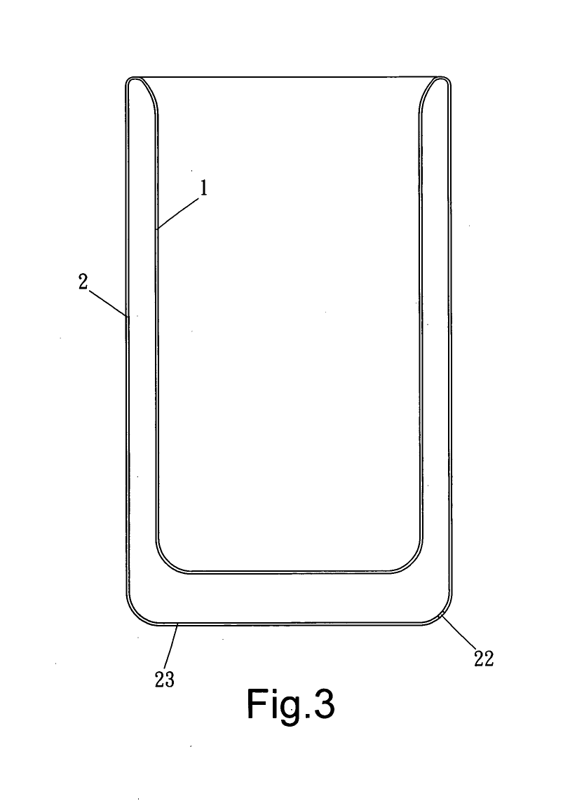

Referring to FIG. 3, a portion of the tubular outer glass (2) used as the bottom of a container to be made is bored to form a through hole (22). As the bottom portion of the tubular outer glass (2) is sealed, the through hole (22) serves as a gas-permeable hole. Next, the bottom portion of the tubular outer glass (2) is closed to shape the bottom (23) of a container, so as to fabricate the model of a double-glazing container.

Referring to FIG. 3 again, when the container is designed to be equipped with no handle (3) or beak (24), the through hole (22) is blocked thereafter. Thus, a double-glazing container without a handle (3) or a beak (24) is manufactured.

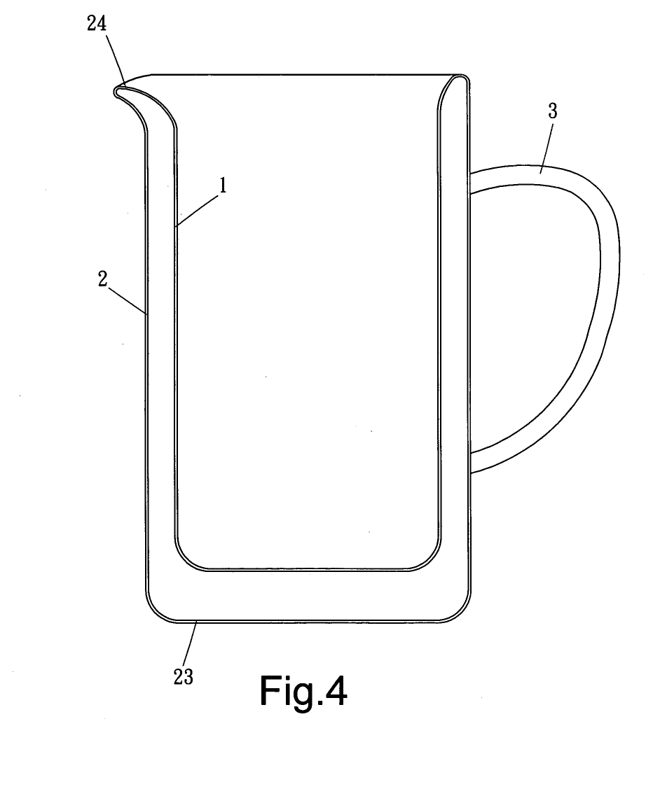

Referring to FIG. 4, if it is desired to dispose a handle (3) or a beak (24) on a container, the handle (3) is attached thereon and the beak (24) is formed before the through hole (22) is plugged. Accordingly, a double-glazing container is fabricated.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A method of fabricating a double-glazing container, comprising:
putting a U-shaped inner glass into a tubular outer glass;
fusing a top edge of the U-shaped inner glass with a top edge of the tubular outer glass;
perforating a bottom of the tubular outer glass to form a through hole, the through hole serves as a gas-permeable hole after bottom-sealing; and
sealing the bottom of the tubular outer glass to form a bottom of the container, and thereby a model of the double-glazing container is formed,
wherein if it is planned to not dispose a handle or a beak onto the container, the through hole is plugged, and the double-glazing container without a handle or a beak is fabricated,
or, if it is planned to dispose a handle or a beak onto the container, a handle is attached or a beak is shaped before the through hole is plugged, and then the double-glazing container with a handle or a beak is fabricated.
